(19) United States
(12) Patent Application Publication
(10) Pub. No.: US 2014/0208641 A1
(43) Pub. Date: Jul. 31, 2014

(54) UPPER AIR INFLOW-TYPE APPARATUS FOR DISSIPATING COLD AIR

(71) Applicants: Seon Yong Lee, Seoul (KR); Kyu Rang Kim, Seoul (KR); Bu Won Yi, Jeollabuk-do (KR); Ji Min Chun, Seoul (KR); Young Jean Choi, Seoul (KR)

(72) Inventors: Seon Yong Lee, Seoul (KR); Kyu Rang Kim, Seoul (KR); Bu Won Yi, Jeollabuk-do (KR); Ji Min Chun, Seoul (KR); Young Jean Choi, Seoul (KR)

(73) Assignee: KOREA METEOROLOGICAL ADMINISTRATION, Seoul (KR)

(21) Appl. No.: 14/240,913

(22) PCT Filed: Jun. 21, 2012
(86) PCT No.: PCT/KR2012/004919

§ 371 Date: Feb. 25, 2014

(30) Foreign Application Priority Data
Aug. 26, 2011 (KR) 10-2011-0085834

(51) Int. Cl. A01G 15/00; E01H 13/00

(52) U.S. Cl. CPC A01G 15/00; E01H 13/00
USPC 47/2; 239/14.1

(57) ABSTRACT

Provided is an upper air inflow-type apparatus for dissipating cold air, the apparatus including: an air inflow fan; an air guiding tube arranged at a lower portion of the air inflow fan; and a descending current divergence zone arranged at a lower portion of the air guiding tube.

### TECHNICAL FIELD

The present invention relates to an upper air inflow-type apparatus for dissipating cold air, and more particularly, to an upper air inflow-type apparatus for dissipating cold air, which is configured such that an air inflow fan in an air inflow apparatus is formed to look down the ground surface, and thus a cold air layer of the ground surface is effectively disrupted by transferring warm air of an upper portion to the land, and thereafter diffusing it on the ground surface, especially, so that orchards can be protected from being damaged due to frost or a cold injury, and fog can dissipate.

### BACKGROUND ART

Frost on crops or cold injury to crops is frequently caused by rational cooling from the ground at dawn on a fine day in spring time in Korea. In particular, a cold injury of orchards generated when petals of the orchards germinate causes a serious problem which influences on a victory or defeat outcome of fruit farms.

The reason why frost or cold injury is caused on a sunny day having no wind is because the temperature of a surface in which air is in contact with the ground descends first, and thus a stable structure having a high temperature according to a gradual increase in height is formed. With regard to this structure, a mechanism to heat cold air of the lower layer is realized by heating by sunrise, and mixing the cold air with air of an upper layer, and since there is no heating mechanism at dawn on a windless day, a temperature of the ground is continuously reduced until the sun rises, thereby causing frost or cold injury.

In this environment, an anti-frost fan for disturbing a stable layer of the air by hanging a ventilator on a highly-erected support to generate the wind has been used in order to disturb the stable air of the ground surface. However, all ventilators of the anti-frost fans, which have been currently marketed and used, are installed at an upper portion of orchards, thereby causing the wind to blow downward. This structure in which the upper air of high temperature is blown above the lower air stratified at low temperature has a limit in effectively disturbing the cold air layer of the ground.

### DISCLOSURE OF INVENTION

### Technical Problem

Accordingly, the present invention has been made keeping in mind the above problems occurring in the prior art, and an object of the present invention is to provide an upper air inflow-type apparatus for dissipating cold air, which is configured such that an air inflow fan is formed to look down the ground surface, and thus a cold air layer of the ground surface is effectively disrupted by transferring warm air of an upper portion to the land, and thereafter diffusing it on the ground surface, especially, so that orchards can be protected from being damaged due to frost or a cold injury, and fog can dissipate.

### Solution to Problem

In order to accomplish the above object, the present invention provides an upper air inflow-type apparatus for dissipating cold air, including: an air inflow fan; an air guiding tube arranged at a lower portion of the air inflow fan; and a descending current divergence zone arranged at a lower portion of the air guiding tube.

### Advantageous Effects of Invention

According to the present invention, it is advantageous in that an air inflow fan is formed to look down the ground surface, and thus a cold air layer of the ground surface is effectively disrupted by transferring warm air of an upper portion to the land, and thereafter diffusing it on the ground surface, especially, so that orchards can be protected from being damaged due to frost or a cold injury, and fog can dissipate.

### BRIEF DESCRIPTION OF DRAWINGS

FIG. 1 is a cross-sectional view illustrating one exemplary embodiment of an entire configuration according to the present invention;

FIG. 2 is a view schematically showing an air inflow fan of the present invention;

FIG. 3 is a view schematically showing a descending current divergence zone of the present invention;

FIG. 4 is a view showing an air inflow apparatus in which one side of a divergent passage part is closed; and

FIG. 5 is a view schematically showing an upper air inflow-type apparatus for dissipating cold air in which two air inflow fans are installed in an upper portion of an air inflow tube.

### BRIEF DESCRIPTION OF THE REFERENCE NUMERALS IN THE DRAWINGS

100: Air inflow fan 200: Air guiding tube

300: Descending current divergence zone 310: Convergent part

320: Divergent part 400: Divergent passage part

410: Support 420: Opening and closing membrane

### Mode for the Invention

Referring to FIGS. 2 to 5, a capacitance-sensitive touch switch 10 (hereinafter referred to as “the touch switch”) according to the present invention is classified roughly into a cover panel 100, an electrostatic panel 200, a support panel 300, and a control board 400.

Exemplary embodiments according to the present invention will now be described more fully hereinafter with reference to the accompanying drawings in such a manner that it could be easily embodied by those skilled in the art to which the present invention pertains. The exemplary embodiments of the present invention may, however, be embodied in many different forms and should not be construed as limited to the embodiments set forth herein. Furthermore, in order to clearly describe the present invention through the drawings, parts which are irrelevant to the description will be omitted, and like numbers refer to like elements through the specification.

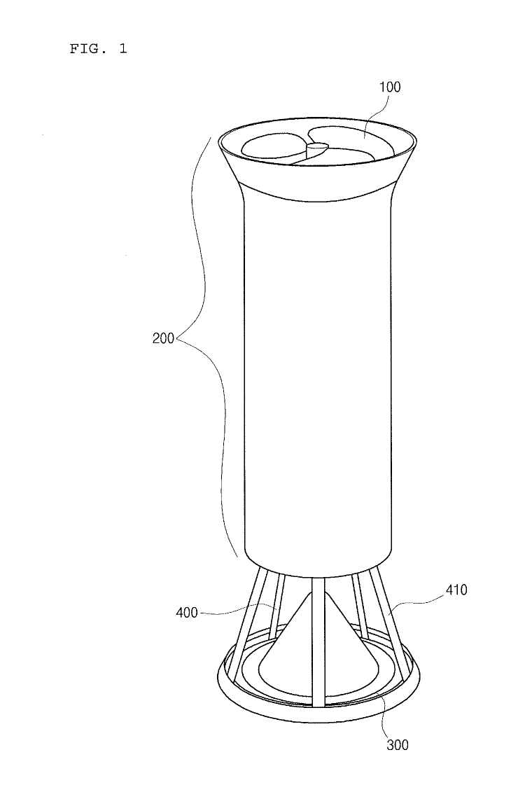

FIG. 1 is a cross-sectional view illustrating one exemplary embodiment of an entire configuration according to the present invention.

Referring to FIG. 1, an upper air inflow-type apparatus for dissipating cold air according to the present invention includes an air inflow fan 100, an air guiding tube 200 arranged at a lower portion of the air inflow fan 100, and a descending current divergence zone 300 arranged at a lower portion of the air guiding tube 200.

The air guiding fan 100 forms an air current which enables upper air to be induced to the lower portion, and any structure may be used as the air guiding fan if the structure can enable air to flow through the air guiding tube 200. That is, in the structure illustrated in FIG. 1, the air inflow fan 100 is one which is generally used in the relevant field, and specifically, FIG. 1 illustrates an example in which the air inflow fan 100 having three or four wings is used. FIG. 2 illustrates an enlarged drawing of the air inflow fan 100. The air inflow fan illustrated in FIG. 2 shows a structure in which three wings are formed without being limited thereto, and the fan structure may be replaced by a motor operated air inflow apparatus.

The air guiding tube 200 is arranged at the lower portion of the air inflow fan 100, and metal, synthetic resin or the like may be used as a material of the air inflow tube 200, but the material is not specifically limited thereto. The air guiding tube 200 serves as a passage for inducing air being present in an upper layer to a lower layer through an operation of the air inflow fan 100. The structure and shape thereof are not limited. Accordingly, the shape of the air inflow tube 200 is one which is typically used in the relevant field, and as the detailed example, the air inflow tube 200 in a cylindrical shape may be used.

A temperature sensing sensor may be further provided on an outer surface of the air guiding tube 200 according to the present invention, and the temperature sensing sensor and the air inflow fan 100 are electrically connected so that the air inflow fan 100 can be operated. That is, when the flow of air is needed, an outer temperature is sensed by the temperature sensing sensor, and an air current is formed by rotating the air inflow fan 10 automatically, thereby enabling the upper and lower air to flow. For this, according to the need, a motor (not drawn) and the like may be disposed in the air guiding tube 200.

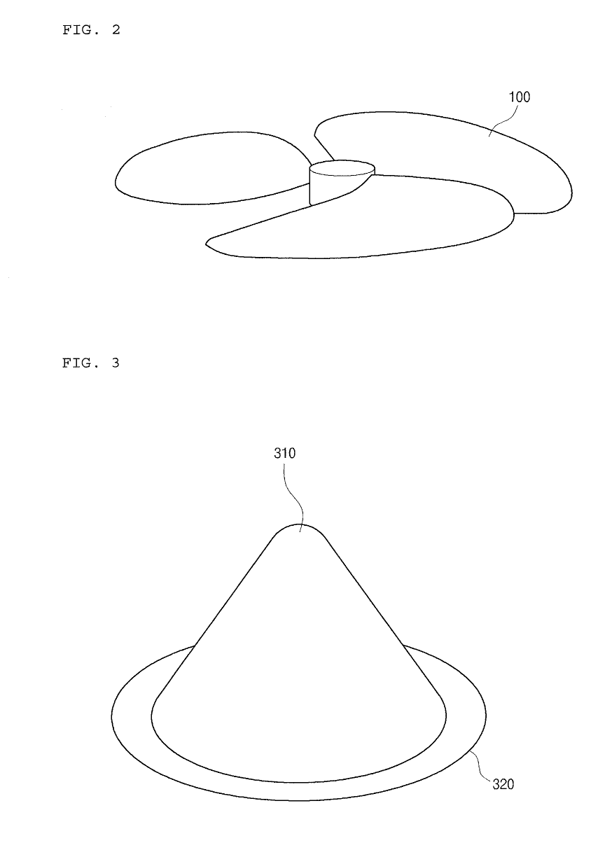

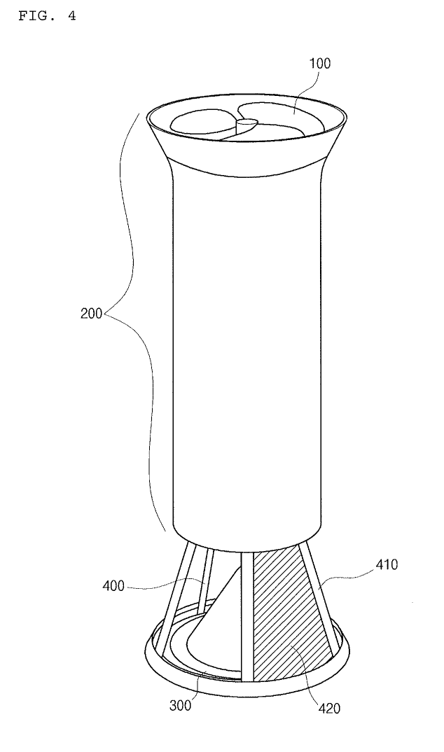

Referring to FIG. 3, the descending current divergence zone 300 includes a convergent part 310 arranged at an upper portion thereof and a divergent part 320 arranged at a lower portion, a length of the divergent part exceeds a length of the convergent part, and a shape of the descending current divergence zone 300 may be implemented in a pyramidical shape, a conical shape, or the like without being limited thereto. Metal, synthetic resin or the like may be used as a material of the descending current divergence zone 300, but the material is not specifically limited thereto.

Thanks to the descending current divergence zone 300 having the pyramidical shape and the conical shape, diffusion of air currents flowing through the air guiding tube 200 may be easily performed. That is, the descending current divergence zone may be formed in a structure in which the air flowing to the lower portion of the air guiding tube 200 is diffused in a vertical direction or a specific direction, rather than a structure in which the air is discharged in a vertical lower portion.

This will be hereinafter described in more detail.

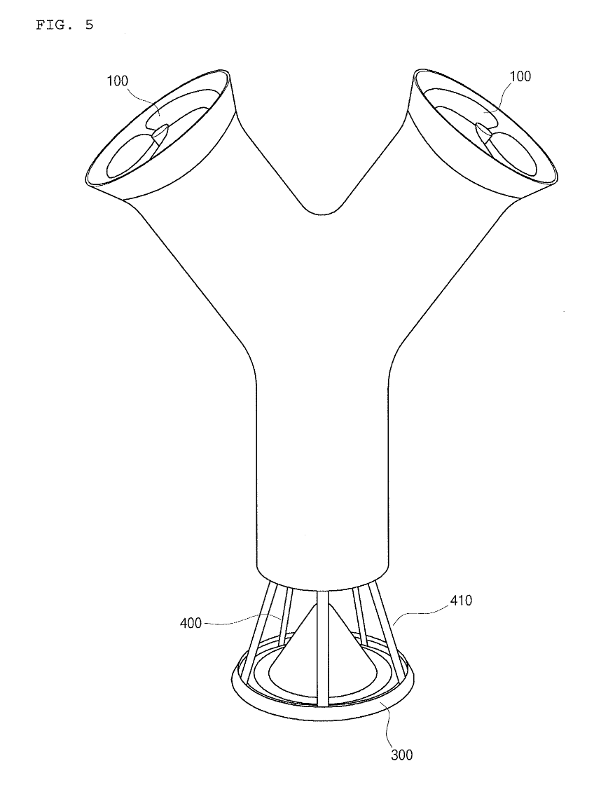

As illustrated in FIGS. 1 and 4, a divergent passage part 400 is connected to a lower portion of the air guiding tube 200, and as shown in FIG. 1, the divergent passage part 400 may be implemented by connecting a plurality of supports 410 to the lower portion of the air guiding tube 200. A material, size, thickness and the like of the supports 410 are not limited.

The currents of air flowing into down the air guiding tube 200 through the divergent passage part 400 may be diffused in all directions.

As shown in FIG. 4 below, the divergent passage part 400 may be implemented in an opening and closing form. Specifically, among the plurality of supports 410 of the divergent passage part 400, by closing a gap between a support 410 and an adjacent support 410, the current of air flowing down through the air guiding tube 200 may be diffused in a desired direction. FIG. 2 below show detailed one example of the divergent passage part 4100 to which an opening and closing membrane 420 is connected.

An upper air inflow-type anti frost apparatus according to the present invention may further include two or more upper supports (not drawn) at an upper portion of the air guiding tube 200.

Also, the upper air inflow-type apparatus for dissipating cold air according to the present invention may further include the air inflow fan 100 by an upper portion of the air inflow tube 200 being divided into a plurality of air guiding tubes. FIG. 5 below shows detailed one example thereof without being limited thereto.

The upper air inflow-type apparatus for dissipating cold air according to the present invention may further include the plurality of the divergent passage parts 400 or the descending current divergence zones 300 at the lower portion of the air guiding tube 200.

A shape of the upper air inflow-type apparatus for dissipating cold air according to the present invention may be a cylindrical shape as shown in FIG. 1 or FIG. 2, but the shape is not limited thereto.

The upper air inflow-type apparatus for dissipating cold air according to the present invention may function to prevent orchards from frog or a cold injury and to dissipate fog, but the field of use is not limited thereto.

The foregoing is illustrative of embodiments and is not to be construed as limiting thereof. Although a few embodiments have been described, those skilled in the art will readily appreciate that many modifications are possible in embodiments without materially departing from the novel teachings and advantages. Accordingly, all such modifications are intended to be included within the scope of this inventive concept as defined in the claims. In the claims, means-plus-function clauses are intended to cover the structures described herein as performing the recited function, and not only structural equivalents but also equivalent structures.

What is claimed is:

1. An upper air inflow-type apparatus for dissipating cold air, the apparatus comprising: an air inflow fan; an air guiding tube arranged at a lower portion of the air inflow fan; and a descending current divergence zone arranged at a lower portion of the air guiding tube.

2. The apparatus of claim 1, wherein the descending current divergence zone comprises a convergent part of an upper portion and a divergent part of a lower portion, wherein a length of the divergent part exceeds that of the convergent part.

3. The apparatus of claim 2, wherein the descending current divergence zone has a pyramidical shape or a conical shape.

4. The apparatus of claim 1, wherein a divergent passage part is connected to the lower portion of the air inflow tube.

5. The apparatus of claim 4, wherein the divergent passage part comprises a plurality of supports.

6. The apparatus of claim 4, wherein the divergent passage part is formed in an opening and closing form.

7. The apparatus of claim 1, further comprising two or more upper supports at an upper portion of the air guiding tube.

8. The apparatus of claim 1, further comprising a plurality of air inflow fans at the upper portion of the air guiding tube.

9. The apparatus of claim 1, further comprising a plurality of divergent passage parts or a plurality of descending current divergence zones at the lower portion of the air guiding tube.

10. The apparatus of claim 1, further comprising a temperature sensing sensor on an outer surface of the air guiding tube, and the temperature sensing sensor and the air inflow fan are electrically connected.

11. The apparatus of claim 1, wherein an upper air inflow-type anti frost apparatus has a cylindrical shape.
